(19) United States
(12) Patent Application Publication
(10) Pub. No.: US 2019/0044237 A1
(43) Pub. Date: Feb. 7, 2019

(54) ENERGY HARVESTING CIRCUIT BOARD

(71) Applicant: Drayson Technologies (Europe) Limited, London (GB)

(72) Inventors: Manuel Pinuela RANGEL, London (GB); Bruno Roberto FRANCISCATTO, London (GB); Vitor Andrade FREITAS, London (GB)

(73) Assignee: Drayson Technologies (Europe) Limited, London (GB)

(21) Appl. No.: 16/076,717

(22) PCT Filed: Feb. 8, 2017
(86) PCT No.: PCT/GB2017/050319

§ 371 Date: Aug. 9, 2018

(30) Foreign Application Priority Data
Feb. 9, 2016 (GB) 1602358.2

(51) Int. Cl. H01Q 9/04; H02J 50/27; H01Q 1/24

(52) U.S. Cl. CPC H01Q 9/0428; H02J 50/27; H01Q 23/00; H01Q 9/0442; H01Q 1/248

(57) ABSTRACT

A circuit board for use in wireless energy harvesting applications is disclosed. The circuit board comprises a first plane and ground plane parallel to the first plane. The ground plane has a substantially rectangular shape with a length less than 1.38 λg and a width less than 0.92 λg. The first plane comprises an antenna, a feedline and a rectifier. The antenna is configured to receive an RF signal with a wavelength of λ₀. The feedline is arranged to filter the received RF signal. The rectifier is arranged to generate a DC voltage from the received RF signal. The antenna, the feedline and the rectifier are arranged substantially co-linear along the first plane, and (formula I) where ε_{eff} is the relative permittivity of a material between the first plane and the ground plane.

### TECHNICAL FIELD

The present invention relates generally to the field of energy harvesting and more specifically to a circuit board with a small size for use in wireless energy harvesting applications.

### BACKGROUND

The wireless transmission of power has attracted considerable interest, and can be classified into two broad categories: wireless energy transfer and wireless energy harvesting. The former is used for high RF power densities (normally to transfer power from dedicated RF sources over short distances) while the latter relates to the harvesting of the much lower RF power densities that are typically encountered in the urban environment (e.g. from WiFi and mobile phone networks).

Wireless energy harvesting systems are generally designed to profit from such freely available RF transmissions by employing highly efficient RF-to-DC conversion to supply low-power devices.

As the power available for energy harvesting is typically of very low density (often 1 μW/cm² or less), providing a circuit which is capable of harvesting such low power levels whilst having a small size is particularly difficult.

In particular, the antenna must have a good return loss, energy losses within the RF energy harvesting circuit must be minimised, and parasitic resistances, capacitances and inductances must be minimised as any parasitic resistance, capacitance or inductance can easily sap away the little energy that has been harvested.

The present invention aims to provide a circuit board for use in wireless energy harvesting applications which exhibits high gain and high efficiency that enable it to harvest energy in an environment with a low power density level of 1 μW/cm², all whilst achieving a small size.

### SUMMARY

The present invention provides a circuit board for use in wireless energy harvesting applications. The circuit board comprises a first plane and ground plane parallel to the first plane. The ground plane has a substantially rectangular shape with a length less than 1.38λ_{g} and a width less than 0.92λ_{g}.

The first plane comprises an antenna, a feedline and a rectifier. The antenna is configured to receive an RF signal with a wavelength of λ₀. The feedline is arranged to filter the received RF signal. The rectifier is arranged to generate a DC voltage from the filtered RF signal. The antenna, the feedline and the rectifier are arranged substantially co-linear along the first plane, and

$${λ}_{g} = \frac{{λ}_{0}}{\sqrt{{ɛ}_{eff}}}$$

where ε_{eff} is the relative permittivity of a material between the first plane and the ground plane.

### BRIEF DESCRIPTION OF THE DRAWINGS

Embodiments of the invention will now be described by way of example only with reference to the accompanying drawings, in which like reference numbers designate the same or corresponding parts, and in which:

FIG. 1 shows a side view of a circuit board according to a first embodiment of the present invention.

FIG. 2 shows a plan view of a first plane of the circuit board according to the first embodiment of the present invention.

FIG. 3 shows a plan view of a first plane of a circuit board according to a second embodiment of the present invention.

FIG. 4 shows a plan view of the first plane of the circuit board according to the second embodiment of the present invention with dimensions.

FIG. 5a shows a simulated 3D gain of the circuit board according to the second embodiment of the present invention.

FIG. 5b shows the coordinate axes used when performing simulations of gain and farfield inverse axial ratio of the circuit board.

FIG. 5c is an alternative view of the plot of FIG. 5a in which the shading of the plot and the colour scale has been adjusted to assist clarity.

FIG. 6a shows the gain of the circuit board according to the second embodiment as it varies with the angle measured from the z-axis, at 0 degrees from the x-axis.

FIG. 6b shows the gain of the circuit board according to the second embodiment as it varies with the angle measured from the z-axis, at 90 degrees from the x-axis.

FIG. 7a shows the farfield inverse axial ratio of the circuit board according to the second embodiment as it varies with the angle measured from the z-axis, at 0 degrees from the x-axis.

FIG. 7b shows the farfield inverse axial ratio of the circuit board according to the second embodiment as it varies with the angle measured from the z-axis, at 90 degrees from the x-axis.

FIG. 8a shows the gain of the circuit board according to the second embodiment as it varies with the angle measured from the z-axis, at 0 degrees from the x-axis. The distance from the antenna to an edge of the first plane is 0.058λ_{g}.

FIG. 8b shows the gain of the circuit board according to the second embodiment as it varies with the angle measured from the z-axis, at 90 degrees from the x-axis. The distance from the antenna to the edge of a first plane is 0.058λ_{g}.

FIG. 9a shows the farfield inverse axial ratio of the circuit board according to the second embodiment as it varies with the angle measured from the z-axis, at 0 degrees from the x-axis. The distance from the antenna to an edge of the first plane is 0.058λ_{g}.

FIG. 9b shows the farfield inverse axial ratio of the circuit board according to the second embodiment as it varies with the angle measured from the z-axis, at 90 degrees from the x-axis. The distance from the antenna to an edge of the first plane is 0.058λ_{g}.

FIG. 10a shows the gain of the circuit board according to the second embodiment as it varies with the angle measured from the z-axis, at 0 degrees from the x-axis. The distance from the antenna to an edge of the first plane is 0.02λ_{g}.

FIG. 10b shows the gain of the circuit board according to the second embodiment as it varies with the angle measured from the z-axis, at 90 degrees from the x-axis. The distance from the antenna to an edge of the first plane is 0.02λ_{g}.

FIG. 11a shows the farfield inverse axial ratio of the circuit board according to the second embodiment as it varies with the angle measured from the z-axis, at 0 degrees from the x-axis. The distance from the antenna to an edge of the first plane is 0.02λ_{g}.

FIG. 11b shows the farfield inverse axial ratio of the circuit board according to the second embodiment as it varies with the angle measured from the z-axis, at 90 degrees from the x-axis. The distance from the antenna to an edge of the first plane is 0.02λ_{g}.

FIG. 12a shows the gain of the circuit board according to the first embodiment as it varies with the angle measured from the z-axis, at 0 degrees from the x-axis. The distance from the antenna to an edge of the first plane is 0.097λ_{g}.

FIG. 12b shows the farfield inverse axial ratio of the circuit board according to the first embodiment as it varies with the angle measured from the z-axis, at 0 degrees from the x-axis. The distance from the antenna to an edge of the first plane is 0.097λ_{g}.

### DETAILED DESCRIPTION OF EMBODIMENTS

### First Embodiment

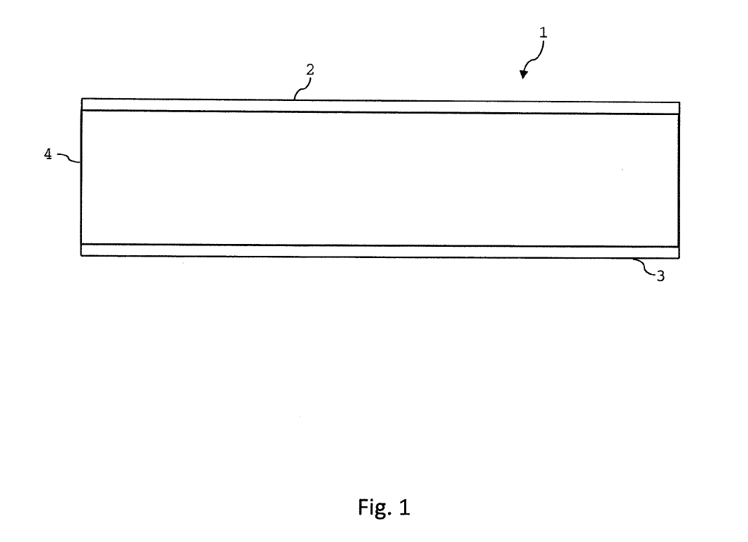

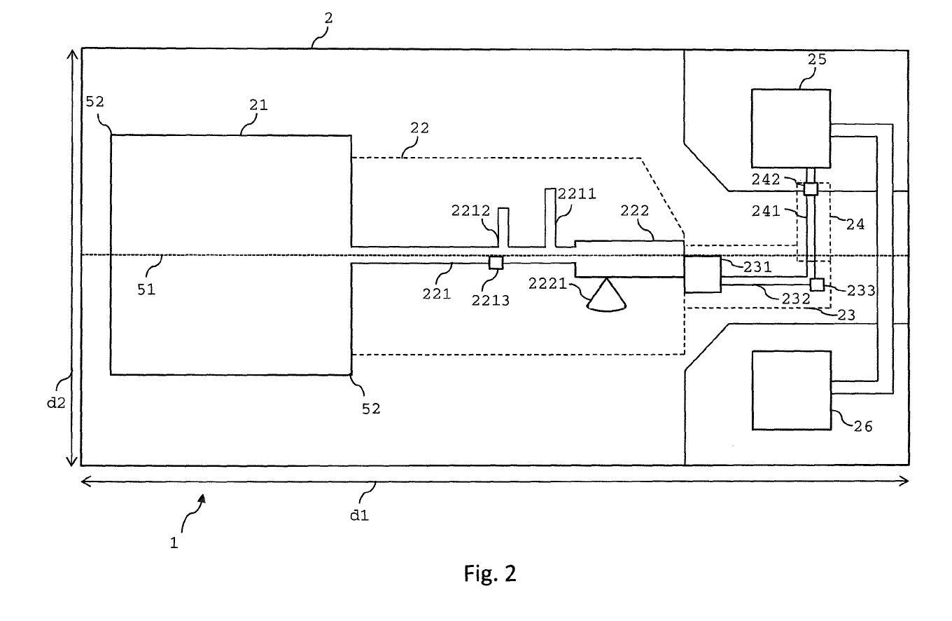

A first embodiment of the present invention will be described with reference to FIGS. 1 and 2, which schematically show the components of a circuit board 1.

The circuit board 1 comprises a first plane 2 and a ground plane 3 substantially parallel to the first plane 2.

As will be explained further later, the first plane 2 and ground plane 3 are conveniently formed as layers on each side of a substrate 4, the substrate 4 being made of a dielectric material.

The circuit board 1 is configured to receive an RF signal with a wavelength of λ₀.

The guided wavelength, λ_{g}, of an electromagnetic wave in a microstrip transmission line differs from the wavelength λ₀ of the same signal in air according to the following formula:

$${λ}_{g} = \frac{{λ}_{0}}{\sqrt{{ɛ}_{eff}}}$$

where ε_{eff} is the effective dielectric constant of the microstrip transmission line, which, for sake of simplicity, is taken to be the relative permittivity of the material of the substrate 4 in the present disclosure. The guided wavelength may, however, alternatively be expressed in terms of an effective dielectric constant that is a function of the microstrip geometry:

$${ɛ}_{eff} = \frac{ɛ + 1}{2} + \frac{ɛ - 1}{2} * \frac{1}{\sqrt{1 + 10 ( \frac{h}{W} )}}$$

where ε is the relative permittivity of the substrate 4, h is the substrate thickness, and W is the width of the conductive trace formed on the substrate. In the following, various dimensions of the circuit board 1 expressed both in terms of mm and λ_{g}. The expression of these dimensions in terms of λ_{g} allows the teachings herein to be applied in the design of circuit boards that can operate at frequencies other than those described. Provided that the relative permittivity of the substrate 4 material is known, the dimensions, in terms of λ_{g}, of various components of a circuit board 1 having the structure described herein may be deduced from measurements or simulations of how harmonics propagate in the circuit board 1, using techniques well-known to those skilled in the art.

Referring to FIG. 2, the first plane 2 and the ground plane 3 are both substantially rectangular in shape with a length d1 less than 1.38λ_{g} and a width d2 less than 0.92λ_{g}, which is equivalent to a length d1 less than 90 mm and a width d2 less than 60 mm at a received frequency of 2.45 GHz for a circuit board 1 with a relative dielectric permittivity of 3.55. However, it will be appreciated that the size of the first plane 2 is given by way of example only and other sizes that are smaller in a length or width dimension of the circuit board 1 may alternatively be used.

The first plane 2 comprises an antenna 21, a feedline 22 and a rectifier 23. The antenna 21, feedline 22 and rectifier 23, as well as the ground plane 3, are all formed from an electrically conductive material, such as copper.

The feedline 22 and the rectifier 23 may take one of many different forms known to those skilled in the art. For example, each of the feedline 22 and the rectifier 23 may be a stripline, microstrip, slotline, coplanar waveguide and a coplanar stripline transmission line, or a combination of two or more of these kinds of transmission line. However, in the present embodiment, each of the feedline 22 and the rectifier 23 takes the form of a microstrip transmission line comprising a respective conductive trace that is formed on the first plane 2, wherein a conductive layer providing the ground plane 3 common to all transmission lines is formed on an opposite side of a substrate 4.

As explained previously, the first plane 2 and ground plane 3 are conveniently formed as layers on each side of the substrate 4. The substrate 4 is made from a dielectric material and provides a suitable mechanical support to hold the first plane 2 and the ground plane 3 in a spaced-apart configuration substantially parallel to each other. It will be understood by the skilled person that “parallel” does not mean that the angle between the first plane 2 and the ground plane 3 is strictly zero degrees, but that variations in the angle up to ±2.5 degrees are encompassed, as such variations will not significantly degrade the performance of the circuit board 1. It will be further understood that the substrate 4 is not an essential component and that any suitable mechanical structure can be provided to hold the first plane 2 and the ground plane 3 in their respective planes.

One example of a material that can be used for the circuit board 1 is Rogers 4003C. Using Rogers 4003C circuit board material provides a total thickness of the first plane 2, substrate 4 and ground plane 3 of substantially 0.0234λ_{g}, equivalent to 1.524 mm at 2.45 GHz in a substrate 4 with a relative dielectric permittivity of 3.55. The skilled person will understand that this dimension is not critical and a variation of ±10% can be encompassed, as such variations will not significantly degrade the performance of the circuit board 1.

The circuit board 1 will exhibit a relative dielectric permittivity which may affect any circuitry placed on the first plane 2. The present inventors have found that a suitable circuit board has a relative dielectric permittivity of between 3.5 and 3.6, preferably 3.55, which is achieved using Rogers 4003C. It will, of course, be appreciated that this choice of circuit board material is given by way of example only, and that other substrate materials (e.g. IS680-345 produced by Isola Corp.™, which has a relative permittivity of 3.45 or a RO3000® series high-frequency laminate) may alternatively be used. The relative permittivity of the substrate material is preferably between 2.17 and 10.2, and more preferably 3.55, as in the present embodiment.

Referring again to FIG. 2, the ground plane 3 shown has the same size as the substrate 4 and the first plane 2. Accordingly, the overall shape of the circuit board 1 is substantially rectangular with a length d1 less than 1.38λ_{g} and a width d2 less than 0.92λ_{g}, which is equivalent to a length d1 less than 90 mm and a width d2 less than 60 mm at a received frequency of 2.45 GHz for a substrate 4 with a relative dielectric permittivity of 3.55. However, it will be appreciated that the size of the ground plane 3 is given by way of example only and other sizes that are smaller in a length or width dimension of the circuit board 1 may alternatively be used.

According to the first embodiment, the antenna 21, feedline 22 and rectifier 23 are arranged substantially co-linear along the first plane 2, as the inventors have found that this reduces energy losses and reduces parasitic resistances, capacitances and inductances. From this, the skilled person will understand that the antenna 21, feedline 22 and rectifier 23 are formed in a line on the first plane 2.

The first embodiment is a single band, co-planar RF energy harvester.

The antenna 21 is configured to receive an RF signal. By way of non-limiting example, such an antenna 21 could be used to receive signals (or energy) in the waveband of Wi-Fi (operating around 2.4 GHz). In particular, the antenna in FIG. 2 is configured to receive an RF signal in the frequency range of 2.4 GHz to 2.5 GHz. Equivalently, the antenna 21 is arranged to receive an RF signal with a wavelength in air between 120 mm and 125 mm. Preferably, for maximum energy reception, the antenna 21 is configured to receive an RF signal with a frequency of 2.45 GHz, which corresponds with a wavelength, λ₀, in air of 122.5 mm. This provides an equivalent λ_{g} value of 65 mm in a substrate 4 with a relative dielectric permittivity of 3.55.

The antenna 21 in the first embodiment is a patch antenna which is provided on the first plane, although it need not be so configured. As shown in FIG. 2, the antenna 21 is substantially square. However, the skilled person will understand that each side of the antenna 21 need not be precisely the same length and that variations on each side of up to ±0.0154λ_{g} (equivalent to ±1 mm at 2.45 GHz in a substrate 4 with a relative dielectric permittivity of 3.55) are encompassed, as such variations will not substantially degrade the performance of the circuit board 1.

The inventors have found that the antenna 21 provides good performance if it is configured so that each side of the antenna 21 has a length between 0.48λ_{g} and 0.50λ_{g}, preferably 0.488λ_{g}, equivalent to a length between 31.2 mm and 32.2 mm, preferably 31.7 mm at 2.45 GHz in a substrate 4 with a relative dielectric permittivity of 3.55. These dimensions were found to exhibit the maximum energy reception of an RF signal with a frequency of 2.45 GHz.

Turning now to the feedline 22, the feedline 22 is arranged to filter the RF signal.

The feedline 22 has an input impedance which substantially matches that of the antenna 21 to ensure a minimal loss of energy at the interface between the antenna 21 and the feedline 22. Furthermore, the feedline 22 has an output impedance which substantially matches that of the rectifier 23 to also ensure a minimal loss of energy at the interface between the feedline 22 and the rectifier 23. Therefore, at the frequency of the received signal, a good match is achieved between the antenna 21 and the rectifier 23 to minimise any reflections at the input side of the rectifier 23. Therefore, the feedline 22 may be arranged to match the impedance between the antenna 21 and the rectifier 23.

The present inventors have found that an impedance of the antenna 21 and the feedline 22 that can be effective to minimise energy loss is substantially 100Ω. More particularly, the present inventors found that, with an impedance of 100Ω, a surprising effect could be achieved because this impedance permits the downsizing of the circuit board 1 without adversely affecting its performance. In particular, the selection of an impedance of substantially 100Ω enables a reduction in size of the antenna 21 and rectifier 22. For example, the present inventors found that the circuit board 1 could perform all the required functions when the impedance was substantially 100Ω and the dimensions of the ground plane 3 were substantially 1.32λ_{g} by 0.831λ_{g} which is equivalent to 85.7 mm by 54 mm at 2.45 GHz in a substrate 4 with a relative dielectric permittivity of 3.55, approximately the size of a typical credit card. Moreover, a reduction of the insertion loss, which is the power loss due to the insertion of devices on the transmission line (e.g. the feedline 22), was found.

In one configuration, the feedline 22 may achieve the filtering of the received RF signal by reflecting RF harmonics generated by the rectifier 23 back towards the rectifier 23. This can be useful because the energy harvested is at a very low level so it is beneficial to keep as much energy as possible within the circuit board 1. Therefore, the feedline 22 is configured to reflect harmonics back towards the rectifier to thereby keep energy within the circuit board 1 which would otherwise be reradiated by the antenna 21. The harmonics are reflected back towards the rectifier 23 so that some of their power can be converted by the rectifier 23 to DC, improving the efficiency of the rectification.

By way of example, the feedline 22 may comprise a number of different structures to reflect the harmonics generated by the rectifier 23. The feedline 22 may comprise a first part 221 and a second part 222. As depicted in FIG. 2, the first and second parts 212, 222 of the feedline may have different widths and lengths. Reflecting of the harmonics may also be aided by the first part 221 comprising a first stub 2211, a second stub 2212 and a first inductor 2213. Each stub may have differing lengths to thereby reflect different harmonics generated by the rectifier 23. Moreover, the second part 222 may comprise a capacitor fan 2221 to help ensure that the primary harmonic, f0, is well matched from the antenna 21 into the rectifier 23.

The feedline 22 may be arranged to reflect the second and third harmonics generated by the rectifier 23. More particularly, the first stub 2211 may be configured to reflect the second harmonic and the second stub 2212 may be configured to reflect the third harmonic. Of course, other harmonics may be optionally reflected instead or as well.

The feedline 22 may be configured as described in UK patent application number 1516280.3 titled “RF-to-DC converter” and filed on 14 Sep. 2015, the full contents of which are incorporated herein by cross-reference.

The rectifier 23 is configured to generate a DC voltage from the received signal. The rectifier 23 may be implemented in a number of different ways. The present inventors found that using a diode 231, a second feedline 232 and a capacitor 233 to form the rectifier 23 is particularly effective.

In particular, the rectifier 23 is arranged to rectify the received RF signal and thereby generate a DC signal. In the rectification of the received RF signal, the rectifier 23 will generate harmonic RF signals on both the input and output sides of the rectifier 23. Therefore, the total energy in the circuit board 1 comprises a mix of DC, fundamental frequency, second harmonic, third harmonic and higher harmonic signals of the received RF signal, in addition to the received RF signal itself.

However, due to good matching of the antenna 21 to the rectifier 23, the reflection generated by the rectifier 23 at the fundamental frequency of the received RF signal will be diminished. This good matching is achieved by way of the feedline 22, as described previously.

The present inventors have also considered further components that may be formed in the first plane 2 to achieve further advantages.

In particular, the first plane 2 may further comprise a low pass filter 24. The low pass filter 24 is arranged to output the DC voltage generated by the rectifier 23. The low pass filter 24 may comprise a third feedline 241 and a second inductor 242.

Alternatively or in addition to the low pass filter 24, the first plane 2 may also comprise a power management module 25. The power management module 25 is arranged to store the DC voltage generated by the rectifier 23 which may have been output by the low pass filter 24. In situations such as energy harvesting, the collected energy at any instant in time is extremely low because the energy density is low. Accordingly, to make use of the collected energy, the energy must be stored and accumulated before it can be utilised. A number of options exist to provide this functionality and the present inventors have found that a power management module 25 is one effective way to store and accumulate the energy generated.

However, the input impedance of the power management module 25 is high and therefore harmonic RF energy generated by the rectifier 23 may be lost. To prevent this, the low pass filter 24 may be configured to reflect the RF harmonics back towards the rectifier 23, to thereby keep the harmonic RF energy in the circuit board 1. Therefore, the low pass filter 24 is configured to output substantially only the DC voltage generated by the rectifier 23.

To achieve this, the low pass filter 24 may comprise a third feedline 241 and a second inductor 242. The second inductor 242 is configured to perform a ‘low-pass’ function in that it allows DC energy to flow but blocks the flow of RF energy and reflects the RF energy back towards the rectifier 23. The harmonics are reflected back towards the rectifier 23 so that some of their power can be converted by the rectifier 23 to DC, improving the efficiency of the rectification.

The present inventors have also found that the positioning of the power management module 25 is important. In particular, the inventors found that positioning the power management module 25 such that it was further than four times the dielectric thickness away from any part of the antenna 21, feedline 22 or rectifier 23 minimised parasitic effects to less than 1%. The dielectric thickness is the distance between the first plane 2 and the ground plane 3. In the first embodiment, therefore, as described previously and depicted in FIG. 2, the present inventors found that the power management module 25 should be positioned at a distance greater than 0.094λ_{g} from any part of the antenna 21, feedline 22 or rectifier 23 in order to minimise the parasitic effects. This is equivalent to 6.1 mm at 2.45 GHz in a substrate 4 with a relative dielectric permittivity of 3.55.

The present inventors also found that, in addition to a power management module 25, the first plane 2 may comprise a load 26. The load 26 may be arranged to be driven by the power management module 25. The load 26 may be implemented in a number of different ways, for example, a resistor is a typical load 26 that would utilise harvested RF energy to cause a current to flow through the load 26.

### Second Embodiment

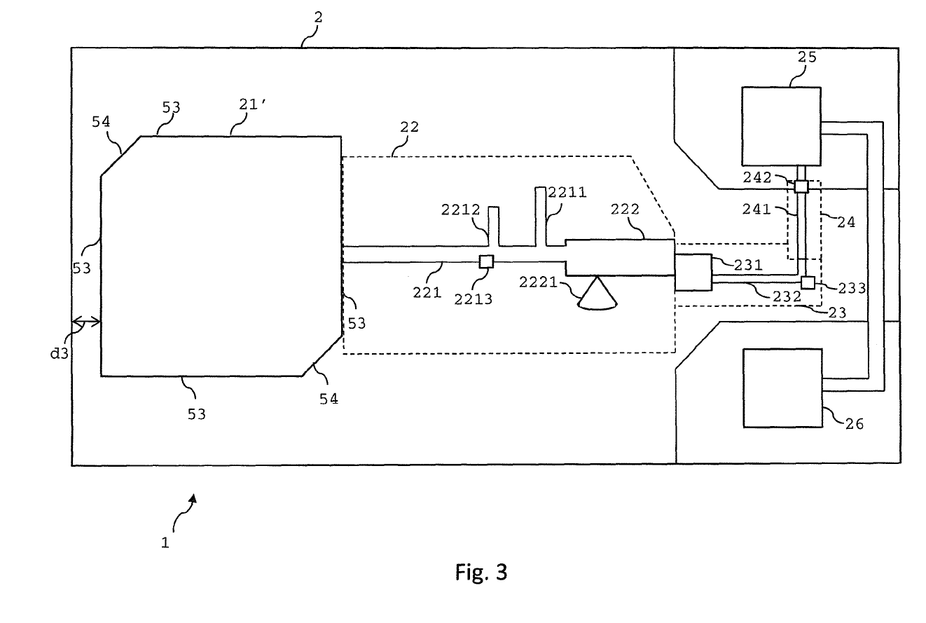

FIG. 3 shows a second embodiment of the present invention. The second embodiment has a different type of antenna 21′ to that of the first embodiment, but all other components and their functions are the same.

In particular, the antenna 21′ differs in its formation on the circuit board 1. The antenna 21′ of the second embodiment is substantially square, with two diagonally opposed corners 52 (as shown in FIG. 2) having been removed such that neighbouring sides 53 of the square are connected by straight lines. The connecting straight lines 54 are provided at substantially the same angle so that the straight lines 54 are substantially parallel.

The inventors found that an optimum length for each connecting straight line 54 was between 0.063λ_{g} and 0.078λ_{g}, preferably, 0.07λ_{g}. This is equivalent to between 4.1 mm and 5.1 mm, preferably 4.6 mm at 2.45 GHz in a substrate 4 with a relative dielectric permittivity of 3.55.

From this description, the skilled person will understand that, in plan form, the antenna 21′ has six sides, with four sides having substantially the same length and the other two sides having a different length. In other words, the antenna 21′ looks like the substantially square antenna 21 of the first embodiment but with triangular corner sections removed from two diagonally opposite corners 52 of the antenna 21. That is, the 0.488λ_{g} by 0.488λ_{g} square antenna 21 of the first embodiment is modified to remove an isosceles triangle from two diagonally opposite corners 52. That is equivalent to 31.7 mm by 31.7 mm square antenna 21 at 2.45 GHz in a substrate 4 with a relative dielectric permittivity of 3.55. Each triangle has a base length of 0.05λ_{g}, so that each connecting straight line 54 has a length of 0.07λ_{g}. That is equivalent to a triangle with a base length of 3.25 mm, so that each connecting straight line 54 has a length of 4.6 mm at 2.45 GHz in a substrate 4 with a relative dielectric permittivity of 3.55.

The antenna 21′ of the second embodiment has the advantageous effect of capturing circularly polarized RF signals which ensures that the maximum amount of RF energy is harvested irrespective of the orientation of the circuit board 1.

The present inventors have found that the gain of the antenna 21′ is greater than 5 dBi (relative to an isotropic antenna) and the farfield inverse axial ratio is less than 2 dB (0 dB is the ideal for circularly polarised fields).

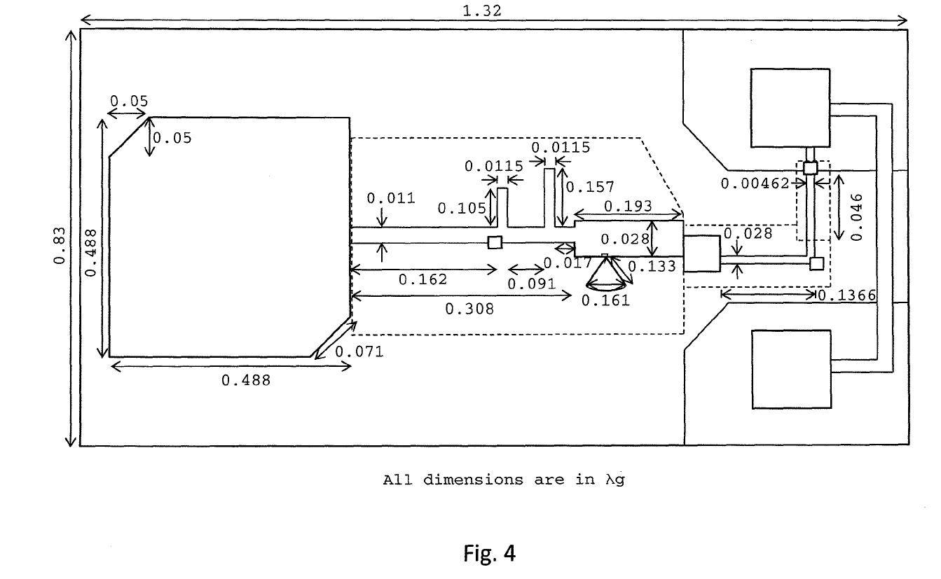

The present inventors also investigated a number of dimensions to be considered when constructing the circuit board 1 depicted in FIG. 3. FIG. 4 provides exemplary dimensions of the various microstrips used for the feedline 22 and the rectifier 23 on the first plane 2.

As will be understood by the skilled person, the dimensions depicted in FIG. 4 need not be exact and a range of values may be used without adversely affecting the performance of the circuit board 1. The dimensions are expressed in λ_{g}, however, the equivalent dimension in mm at 2.45 GHz in a substrate 4 with a relative dielectric permittivity of 3.55 are also provided in brackets.

Firstly, the ground plane 3 may have a length of 1.32λ_{g} (85.7 mm) and a width of 0.831λ_{g} (54 mm). This is roughly the size of a credit card. As explained previously, the circuit board 1 itself may have the same dimensions as the ground plane 3 or have a large size, preferably the circuit board 1 will have the same size as the ground plane 3.

Regarding the feedline 22, this comprises a first part 221 and a second part 222, arranged co-linearly. The first part may be 0.308λ_{g} (20.03 mm) long and 0.011λ_{g} (0.7 mm) wide. The second part 222 may be 0.193λ_{g} (12.52 mm) long and 0.028λ_{g} (1.8 mm wide).

The first part 221 comprises a first stub 2211, a second stub 2212 and a first inductor 2213. The first stub 2211 may have a length of 0.157λ_{g} (10.22 mm) and a width of 0.0115λ_{g} (0.75 mm). The first stub 2211 may be positioned 0.017λ_{g} (1.11 mm) from the second part 222 of the feedline. The second stub 2212 may have a length of 0.105λ_{g} (6.84 mm) and a width of 0.0115λ_{g} (0.75 mm). The second stub 2212 may be positioned 0.091λ_{g} (5.92 mm) from the first stub 2211. The first inductor 2213 has one end connected to the first part 221 of the feedline and its other end connected to ground. The first inductor 2213 may have a value of 10 μH. The first inductor 2213 provides a return path via ground for DC energy on the input side of the rectifier 23, thereby forming a DC loop and making DC energy available at the output side of the rectifier 23. In particular, the first inductor 2213 performs a ‘low-pass’ function in that it allows DC energy to flow but blocks the flow of RF energy. The first inductor 2213 may be placed 0.162λ_{g} (10.5 mm) from the meeting point of the antenna 21 and the first part of the feedline 221.

The second part 222 further comprises a capacitor fan 2221. The capacitor fan 2221 may have a radius of 0.133λ_{g} (8.64 mm) and a chord length of 0.161λ_{g} (10.46 mm). These dimensions equate to an inside arc angle of substantially 74.5 degrees, which is the angle between the two walls of the capacitor fan 2221.

The rectifier 23 comprises a diode 231, a second feedline 232 and a capacitor 233. The second feedline 232 may have a length between 0.1363λ_{g} (8.86 mm) and 0.1369λ_{g} (8.90 mm) and a width between 0.026λ_{g} (1.7 mm) and 0.029λ_{g} (1.9 mm). The second feedline 232 may have a length of 0.1366λ_{g} (8.88 mm) and a width of 0.028λ_{g} (1.8 mm). The capacitor 233 may have a value of 10 pF. The capacitor 233 helps to ensure that the primary harmonic, f0, is well matched into the next stage.

The optional low pass filter 24 comprises a third feedline 241 and a second inductor 242. The second inductor 242 may have a value of 10 μH. The third feedline 241 may have a length between 0.045λ_{g} (2.9 mm) and 0.048λ_{g} (3.1 mm) and a width between 0.0031λ_{g} (0.2 mm) and 0.0062λ_{g} (0.4 mm). The third feedline 241 may have a length of 0.046λ_{g} (3 mm) and a width of 0.0046 (0.3 mm).

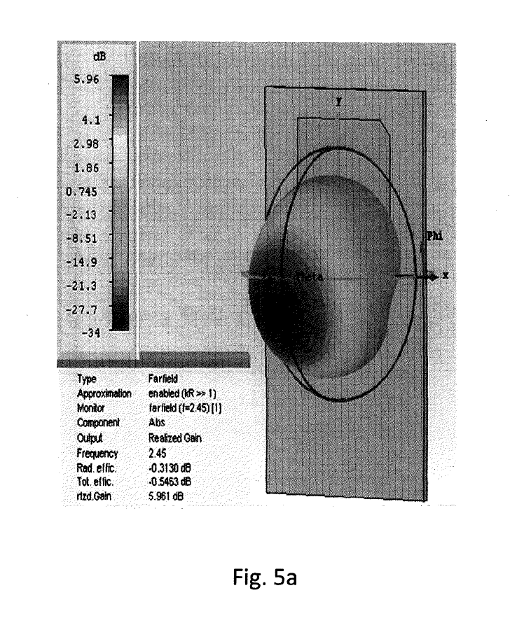

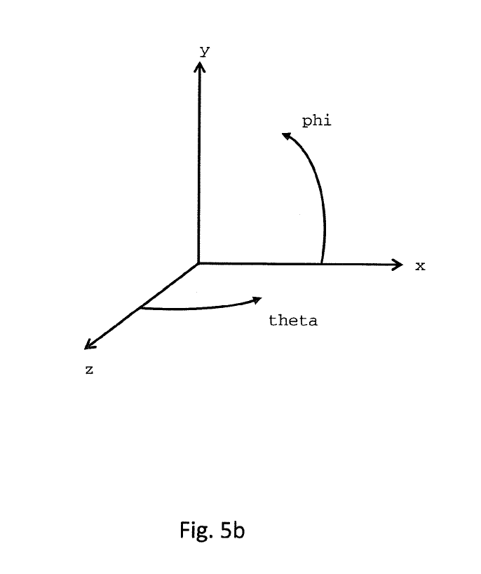

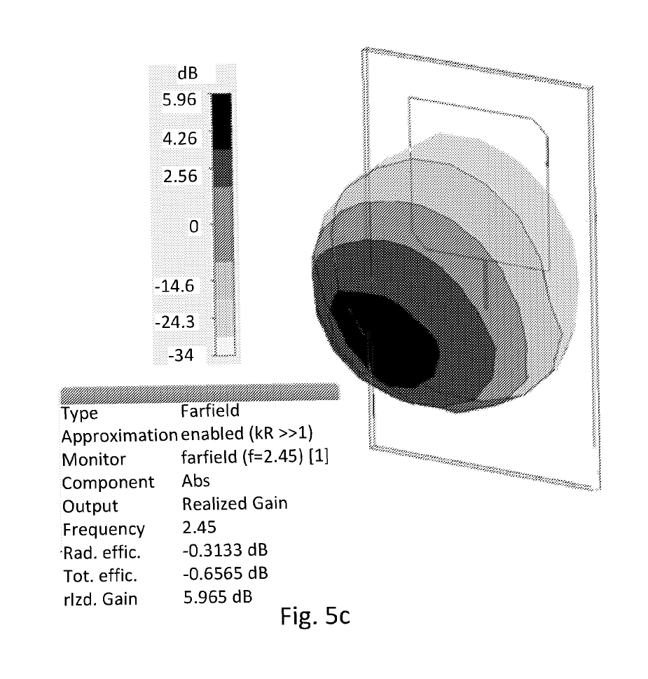

The present inventors modelled the expected gain from the circuit board according to the second embodiment. FIG. 5a shows the 3D gain exhibited by the antenna 21′ of the second embodiment. The gain of an antenna describes how much power is received in the direction of peak radiation to that of an isotropic source.

FIG. 5b shows the coordinate axes used during the modelling. The coordinate axes are arranged such that the x-axis lies in the first plane 2 and extends in the same directory as the width dimensions d2 (as shows in FIG. 2), while the y-axis lies in the first plane 2 and extends in the same direction as the length dimension d1 (as shown in FIG. 2). The z-axis extends perpendicular from the first plane 2. In addition two angles are defined. Angle phi is the angle measured anti-clockwise from the x-axis towards the y-axis. Angle theta is the angle measured anti-clockwise from the z-axis towards the x-axis.

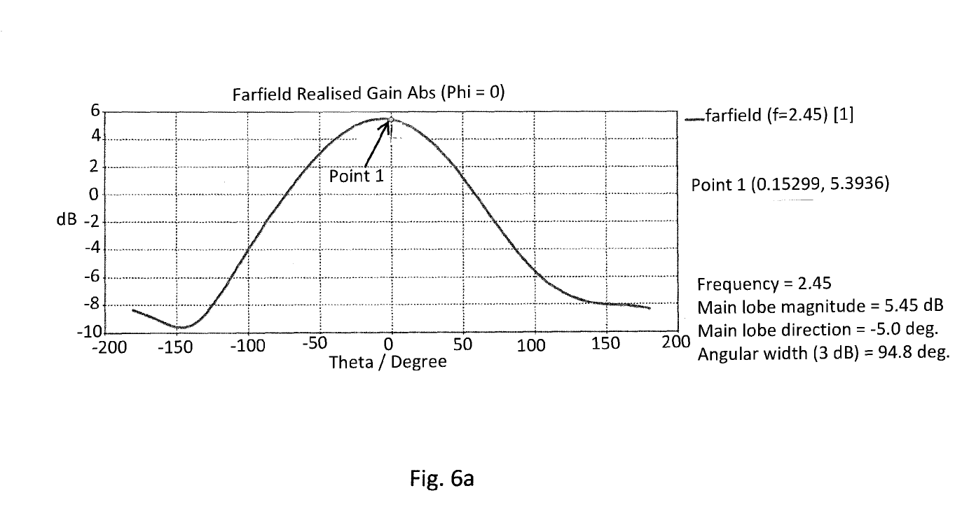

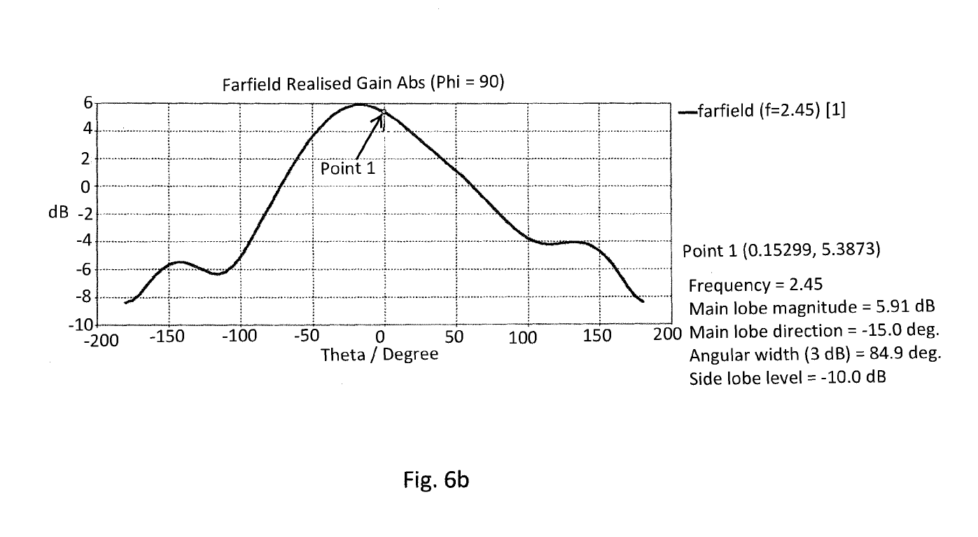

FIG. 6a shows the antenna gain as theta varies. FIG. 6a is modelled for phi at 0 degrees.

Similarly, FIG. 6b shows the antenna gain as theta varies but for phi having a value of 90 degrees.

From both FIGS. 6a and 6b, the present inventors found that a gain in excess of 5.4 dB could be achieved at a frequency of 2.45 GHz.

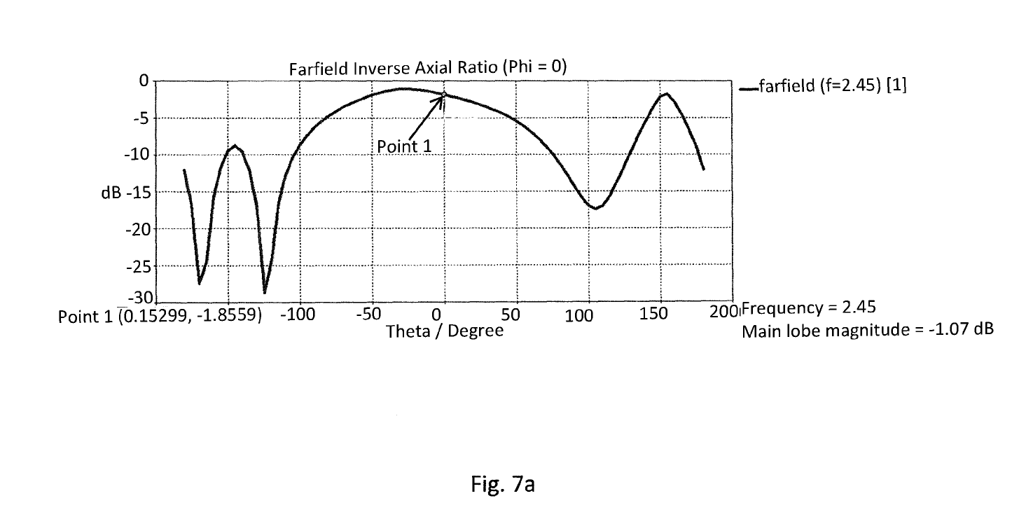

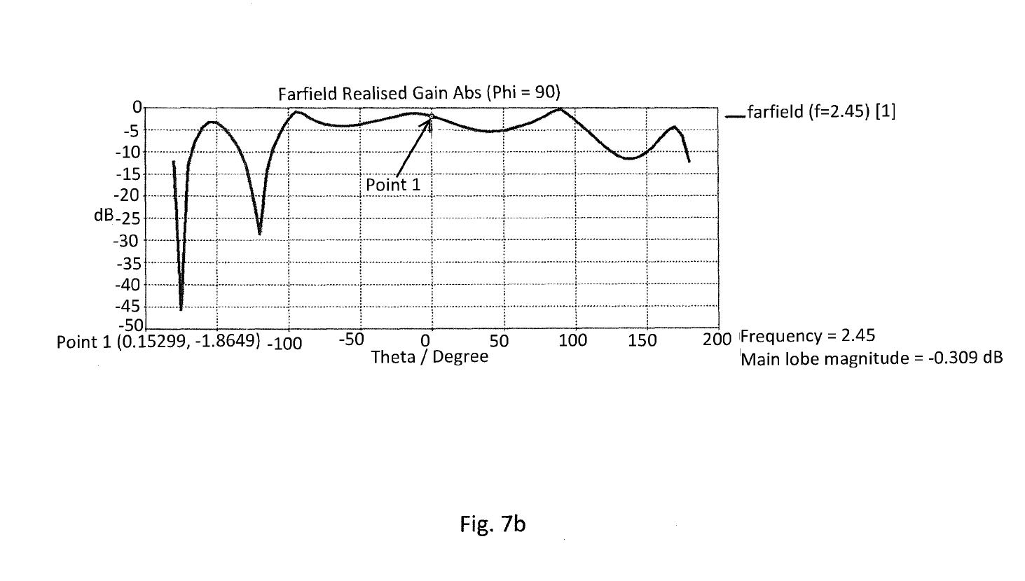

FIG. 7a shows how the farfield inverse axial ratio varies with theta. In this simulation, phi was fixed at 0 degrees. For antennas, the farfield inverse axial ratio is the ratio of orthogonal components of the received E-field. The ideal value of the farfield inverse axial ratio for received circularly polarized fields is 0 dB. For the circuit board 1 of the second embodiment, FIG. 7a shows a farfield inverse axial ratio of 1.86 dB for a theta value of 0 and a phi value of 0 degrees.

FIG. 7b shows how the farfield inverse axial ratio varies with theta. In this simulation phi was fixed at 90 degrees. The farfield inverse axial ratio was found to be 1.86 dB for theta at 0 degrees.

From both FIGS. 7a and 7b, the present inventors found that a farfield inverse axial ratio of, on average, 1.86 dB could be achieved at a frequency of 2.45 GHz.

The distance d3 (shown in FIG. 3) between the edge of the antenna 21′ and the nearest edge of the first plane 2 was also considered by the present inventors. The inventors found that an optimal distance d3 of 0.097λ_{g} ensured the maximal gain of the antenna 21′, without substantially affecting the farfield inverse axial ratio. Indeed, for all of FIGS. 5a, 6a, 6b, 7a and 7b, the simulation was performed with a distance d3 between the edge of the first plane 2 and the antenna 21′ of 0.097λ_{g}, equivalent to 6.3 mm at 2.45 GHz in a substrate 4 with a relative dielectric permittivity of 3.55.

To confirm this result, the present inventors performed the same simulation for the circuit board 1 according to the second embodiment but varied the distance d3 between the edge of the antenna 21′ and the nearest edge of the first plane 2.

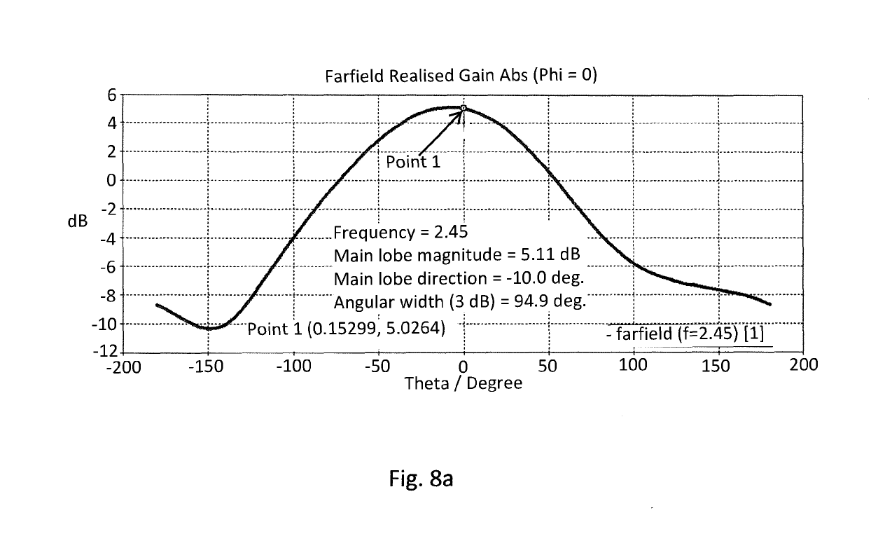

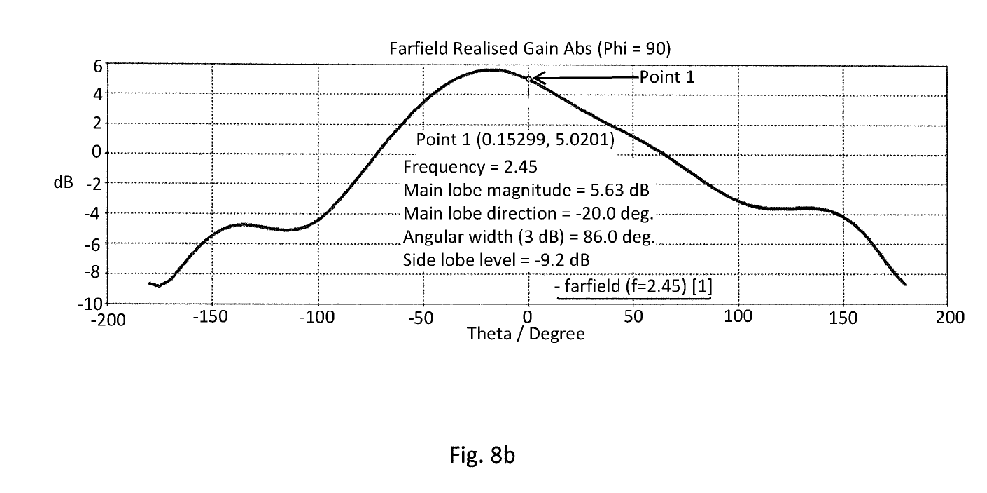

FIGS. 8a and 8b show how the gain varies with theta when phi is 0 degrees and 90 degrees, respectively, for a simulation in which the distance d3 between the antenna 21′ and the nearest edge of the first plane 2 was 0.058λ_{g}, equivalent to 3.8 mm at 2.45 GHz in a substrate 4 with a relative dielectric permittivity of 3.55.

As can be seen, the gain has reduced as compared to the simulation shown in FIGS. 6a and 6b. The gain has fallen to an average value of 5.05 dB.

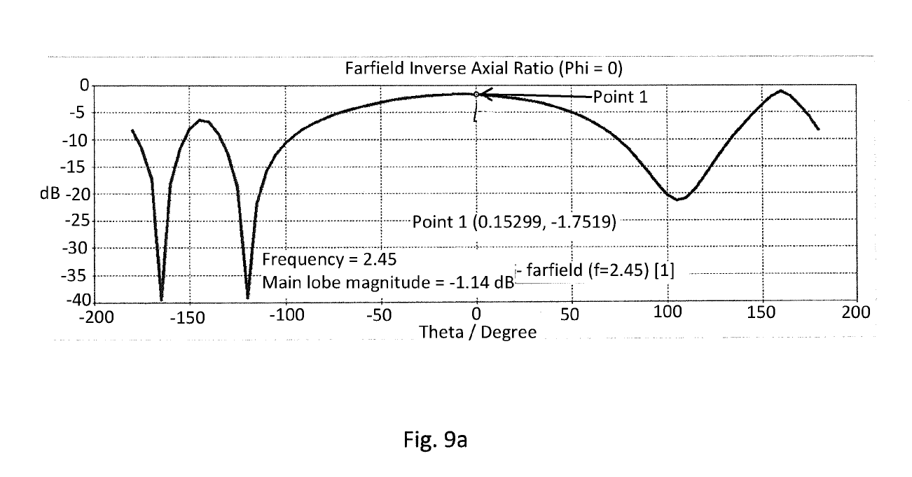

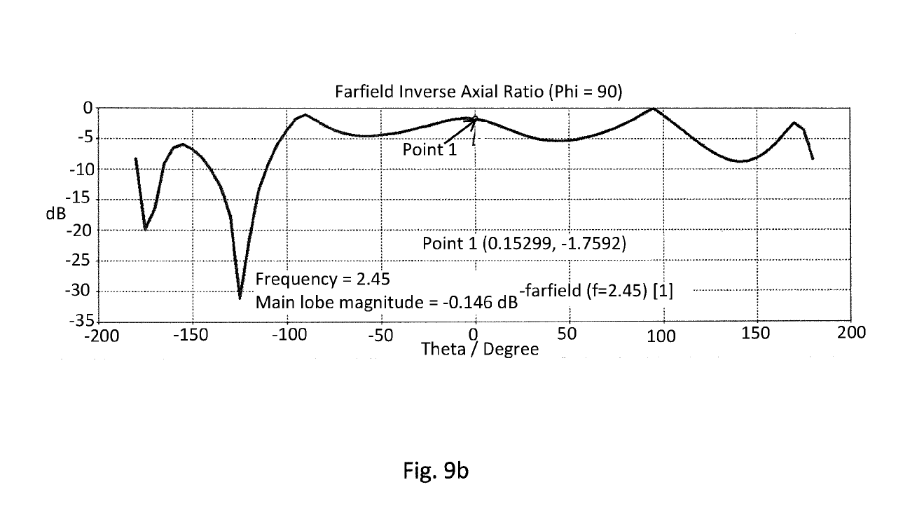

FIGS. 9a and 9b show how the farfield inverse axial ratio varies with theta when phi is 0 degrees and 90 degrees, respectively, for a simulation in which the distance d3 between the antenna 21′ and the nearest edge of the first plane 2 was 0.058λ_{g}, equivalent to 3.8 mm at 2.45 GHz in a substrate 4 with a relative dielectric permittivity of 3.55. As can be seen, the farfield inverse axial ratio has reduced as compared to the simulation shown in FIGS. 7a and 7b. The farfield inverse axial ratio has fallen to an average value of 1.76 dB.

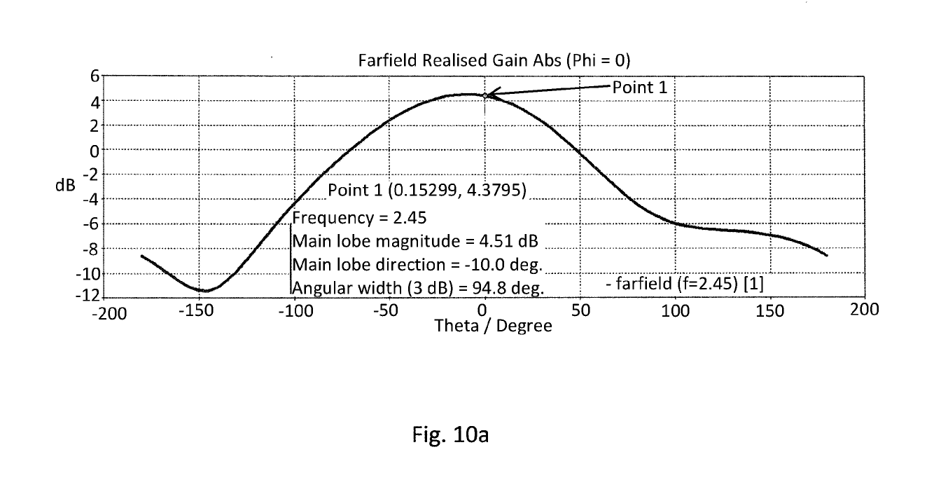

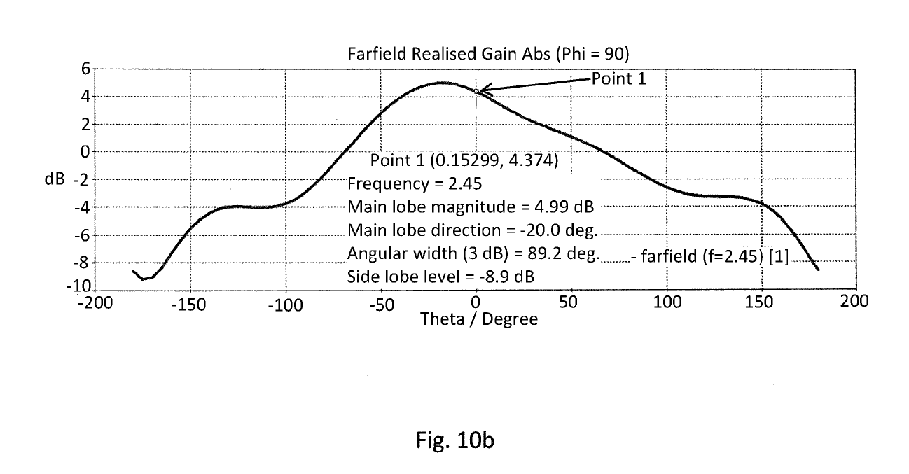

FIGS. 10a and 10b show how the gain varies with theta when phi is 0 degrees and 90 degrees, respectively, for a simulation in which the distance d3 between the antenna 21′ and the nearest edge of the first plane 2 was 0.02λ_{g}, equivalent to 1.3 mm at 2.45 GHz in a substrate 4 with a relative dielectric permittivity of 3.55. As can be seen, the gain has reduced as compared to the simulation shown in FIGS. 6a, 6b, 8a and 8b. The gain has fallen to an average value of 4.75 dB.

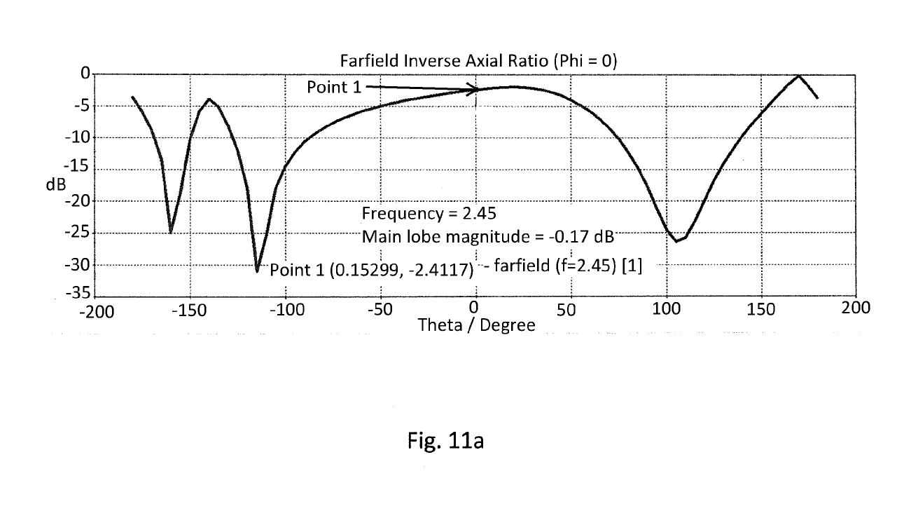

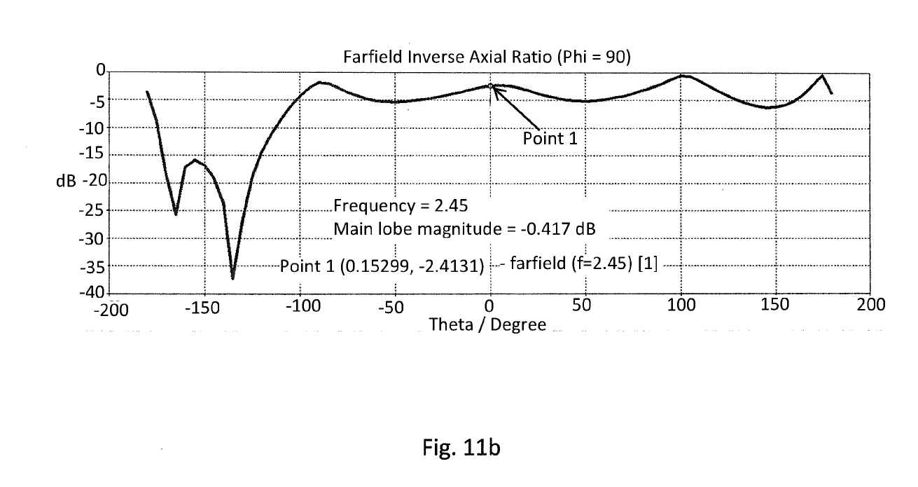

FIGS. 11a and 11b show how the farfield inverse axial ratio varies with theta when phi is 0 degrees and 90 degrees, respectively, for a simulation in which the distance d3 between the antenna 21′ and the nearest edge of the first plane 2 was 0.02λ_{g}, equivalent to 1.3 mm at 2.45 GHz in a substrate 4 with a relative dielectric permittivity of 3.55. As can be seen, the farfield inverse axial ratio has risen as compared to the simulation shown in FIGS. 7a, 7b, 9a and 9b. The farfield inverse axial ratio has risen to an average value of 2.4 dB.

To summarise, the following table details the results:

| Distance d3 of | | |
|---|---|---|
| antenna 21′ from | Average gain at | |
| edge of first plane | 2.45 GHz (theta = 0 | Farfield inverse |
| 2 (λg) | degrees) | axial ratio |
| 0.02 | 4.75 | 2.4 |
| 0.058 | 5.05 | 1.76 |
| 0.097 | 5.39 | 1.86 |

By way of the further comparison, the present inventors performed simulations of the first embodiment of the present invention so that the performance of the first and second embodiments could be compared. In the simulations of the first embodiment, the inventors found that, with a distance d3 of 0.097λ_{g}, equivalent to 6.3 mm at 2.45 GHz in a substrate 4 with a relative dielectric permittivity of 3.55, from the nearest edge of the first plane 2 to the antenna 21, at 2.45 GHz and a theta value of 0 degrees an average gain of 2.8 dB was achieved and an farfield inverse axial ratio of 130.

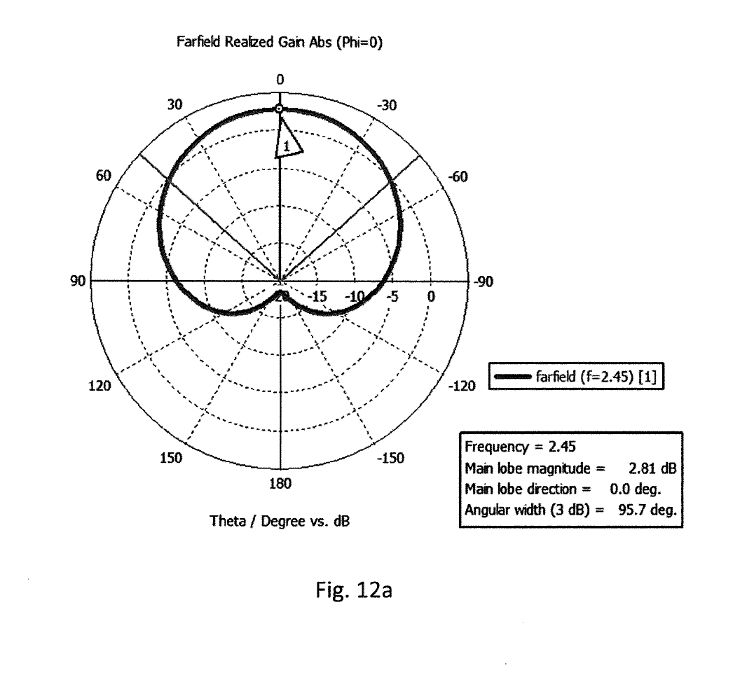

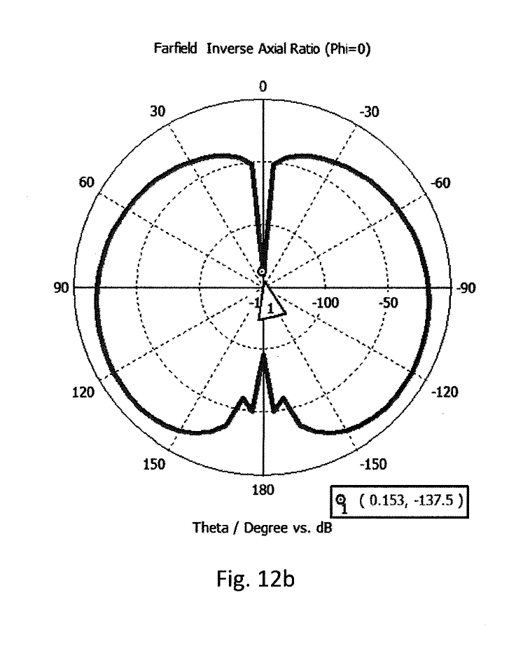

More particularly, FIG. 12a shows how the gain varied with theta when phi was 0 degrees for the simulation of the first embodiment. In this simulation, the distance between the antenna 21 and the nearest edge of the first plane 2 was 0.097λ_{g}, equivalent to 6.3 mm at 2.45 GHz in a substrate 4 with a relative dielectric permittivity of 3.55. As can be seen, the gain has reduced as compared to the second embodiment with an average value of 2.8 dB.

FIG. 12b shows how the farfield inverse axial ratio varies with theta when phi is 0 degrees for the simulation of the first embodiment. In this simulation, the distance between the antenna 21 and the nearest edge of the first plane 2 was 0.097λ_{g}, equivalent to 6.3 mm at 2.45 GHz in a substrate 4 with a relative dielectric permittivity of 3.55. As can be seen, the farfield inverse axial ratio has reduced as compared to the simulations for the second embodiment with an average value of 130 therefore showing linear behaviour, with no circular polarization being present.

### Modifications and Variations

Many modifications and variations can be made to the embodiments described above. For example, in the embodiments described above, the antenna 21, 21′ and feedline 22 had impedances of substantially 100Ω. However, acceptable performance can still be achieved when other impedances, such as the standard 50Ω, are used.

In another example, the first inductor 2213 could be replaced by a connection to the ground plane, preferably being formed by a “via”.

Moreover, the present inventors found that locating the antenna 21, 21′, feedline 22 and rectifier 23 co-linear along a centreline 51 of the first plane 2 can further reduce energy losses and parasitic resistances, capacitances and inductances. FIG. 2 depicts the centreline 51 extending along the longest dimension d1 of the first plane 2. By arranging the antenna 21, 21′, feedline 22 and rectifier 23 co-linear along a centreline 51 of the first plane 1, the inventors have found that losses and parasitic effects can be reduced, whilst keeping the overall size of circuit board 1 small. If the rectifier 23 were off-centre, then the inventors found that the feedline 22 would need to be longer, possibly with bends, and would therefore have more losses and parasitic effects. However, the present inventors also found that the antenna 21, 21′, feedline 22 and rectifier 23 do not need to be sited precisely along the centreline 51 such that the distance between the edge of the first plane 2 and the middle of any part on the antenna 21, 21′, feedline 22 or rectifier 23 is precisely in the middle of the first plane 2. Instead, the present inventors found that variations of up to 0.077λ_{g} (equivalent to 5 mm at 2.45 GHz in a substrate 4 with a relative dielectric permittivity of 3.55) in either direction can be made without significantly degrading the performance of the circuit board 1. Accordingly, the expression “along a centreline of the first plane” should be understood to encompass such variations.

The foregoing description of embodiments of the invention has been presented for the purpose of illustration and description. It is not intended to be exhaustive or to limit the invention to the precise form disclosed. Modifications and variations can be made without departing from the spirit and scope of the present invention.

1. A circuit board for use in wireless energy harvesting applications, comprising a first plane and a ground plane parallel to the first plane, the ground plane having a substantially rectangular shape with a length less than 1.38λ_{g} and a width less than 0.92λ_{g} and the first plane comprising:
an antenna configured to receive an RF signal with a wavelength of λ₀;
a feedline arranged to filter the received RF signal; and
a rectifier arranged to generate a DC voltage from the filtered RF signal;
wherein the antenna, feedline and rectifier are arranged substantially co-linear along the first plane, and
$${λ}_{g} = \frac{{λ}_{0}}{\sqrt{{ɛ}_{eff}}}$$
where ε_{eff} is the relative permittivity of a material between the first plane and the ground plane.

2. The circuit board according to claim 1, wherein the first plane further comprises:
a low pass filter arranged to output the DC voltage generated by the rectifier.

3. The circuit board according to claim 1 or claim 2, wherein the first plane further comprises:
a power management module arranged to store the DC voltage.

4. The circuit board according to claim 3, wherein the power management module is arranged on the first plane at a distance from any part of the antenna, feedline or rectifier of greater than four times the distance between the first plane and the ground plane.

5. The circuit board according to claim 4, wherein the power management module is arranged at a distance greater than 0.094λ_{g} from any part of the antenna, feedline or rectifier.

6. The circuit board according to any of claims 3 to 5, wherein the first plane further comprises:
a load arranged to be driven by the power management module.

7. The circuit board according to any of claims 1 to 6, wherein the antenna is configured to receive an RF signal with a wavelength, λ₀, of between 120 mm and 125 mm.

8. The circuit board according to claim 7, wherein the antenna is configured to receive an RF signal with a wavelength, λ₀, of 122.5 mm.

9. The circuit board according to any of claims 1 to 8, wherein the circuit board has a relative dielectric permittivity of between 2.17 and 10.2.

10. The circuit board according to any of claims 1 to 9, wherein the circuit board material is Rogers 4003C and has a relative dielectric permittivity of 3.55.

11. The circuit board according to any of claims 1 to 10, wherein the antenna is a patch antenna.

12. The circuit board according to claim 11, wherein the antenna is substantially square.

13. The circuit board according to claim 12, wherein each side of the antenna has a length between 0.48λ_{g} mm and 0.50λ_{g}.

14. The circuit board according to claim 13, wherein each side of the antenna has a length of 0.488λ_{g}.

15. The circuit board according to claim 11, wherein the antenna is substantially square, two diagonally opposed corners having been removed such that neighbouring sides of the square are connected by a straight line, the connecting straight lines being provided at substantially the same angle, with the length of each connecting straight line being between 0.063λ_{g} and 0.078λ_{g}.

16. The circuit board according to claim 15, wherein each connecting straight line has a length of 0.07λ_{g}.

17. The circuit board according to any of claims 1 to 16, wherein the feedline is arranged to filter the RF signal by reflecting RF harmonics generated by the rectifier back towards the rectifier.

18. The circuit board according to any of claims 1 to 17, wherein the antenna and feedline each have an impedance of substantially 100Ω.

19. The circuit board according to any of claims 1 to 18, wherein the rectifier comprises a diode, a second feedline and a capacitor.

20. The circuit board according to claim 19, wherein the second feedline has a length between 0.1363λ_{g} and 0.1369λ_{g} and a width between 0.026λ_{g} and 0.029λ_{g}.

21. The circuit board according to claim 20, wherein the second feedline has a length of 0.1366λ_{g} and a width of 0.028λ_{g}.

22. The circuit board according to any of claims 2 to 21, wherein the low pass filter is further arranged to reflect RF harmonics generated by the rectifier back towards the rectifier.

23. The circuit board according to any of claim 22, wherein the low pass filter comprises a third feedline and an inductor.

24. The circuit board according to claim 23, wherein the third feedline has a length between 0.045λ_{g} and 0.048λ_{g} and a width between 0.0031λ_{g} and 0.0062λ_{g}.

25. The circuit board according to claim 24, wherein the third feedline has a length of 0.046λ_{g} and a width of 0.0046λ_{g}.

26. The circuit board according to any of claims 1 to 25, wherein the antenna, feedline and rectifier are arranged substantially co-linear along a centreline of the first plane.
